(19) United States
(12) Patent Application Publication
(10) Pub. No.: US 2024/0280243 A1
(43) Pub. Date: Aug. 22, 2024

(54) PLANAR ILLUMINATION DEVICE

(71) Applicant: MINEBEA MITSUMI Inc., Nagano (JP)

(72) Inventor: Ippei KUSUNOKI, Kitasaku-gun (JP)

(21) Appl. No.: 18/040,692

(22) PCT Filed: Jun. 25, 2021
(86) PCT No.: PCT/JP2021/024248

§ 371 Date: Jun. 8, 2023

(30) Foreign Application Priority Data
Aug. 7, 2020 (JP) 2020-134428

(51) Int. Cl. F21V 7/00; F21V 3/06; F21Y 105/00; F21Y 113/00

(52) U.S. Cl. CPC F21V 7/0083; F21Y 2105/00; F21Y 2113/00; G02F 1/133603

(57) ABSTRACT

In a planar illumination device according to an embodiment, a reflector can be stably fixed to a substrate even when a temperature change occurs. A planar illumination device includes a substrate provided with a plurality of light sources at one surface side, a reflector provided at the one surface side of the substrate, a bottom frame provided at a surface side of the substrate opposite to the one surface side, a first fixing member configured to fix a center portion of the reflector in a longitudinal direction to the bottom frame, and a second fixing member configured to fix the one surface of the substrate and the reflector. A force of the second fixing member restricting the substrate and the reflector is greater at a center portion of the reflector 4 in the longitudinal direction than at a portion of the reflector 4 separated in the longitudinal direction from the center portion.

### CROSS REFERENCE TO RELATED APPLICATIONS

This application claims the benefit of priority to Japanese Patent Application Number 2020-134428 filed on Aug. 7, 2020. the entire contents of the above-identified application are hereby incorporated by reference.

### TECHNICAL FIELD

The disclosure relates to a planar illumination device.

### BACKGROUND

A known direct-lit planar illumination device includes an optical sheet and the like disposed at an emission surface side of a substrate provided with an arranged plurality of light sources. Such a planar illumination device is used as, for example, a backlight in a liquid crystal display device in a vehicle.

In such a known planar illumination device, end parts of an optical sheet are supported and secured by a middle chassis disposed on a base part and an optical member covering a side surface of the optical sheet and the like is provided at the middle chassis. This allows loss of light emitted at the end parts of the optical sheet to be reduced (see JP 2009-16105 A, for example).

In another known planar illumination device, an inner surface of a housing is covered by a reflective film, enhancing brightness (see JP 2008-158505 A, for example).

Another known direct-lit planar illumination device includes a reflector having a reflective surface surrounding the periphery of a light source, with an optical sheet placed on the reflector.

### SUMMARY

However, in the direct-lit planar illumination devices described above, the brightness at the outer peripheral part (in particular, the four corners) of the emission surface is low when compared with edge-lit planar illumination devices.

In light of the foregoing, the disclosure is directed at providing a planar illumination device that can enhance the overall brightness uniformity of an emission surface.

To solve the problems described above and achieve the object described above, a planar illumination device according to an aspect of the disclosure is a planar illumination device including a substrate provided with a plurality of light sources at one surface side; a reflector provided at the one surface side of the substrate; and an optical sheet provided at an emission surface side of the reflector, wherein the reflector covers a periphery of the optical sheet, and the reflector includes an inclined side wall at a periphery, the inclined side wall decreasing in width from the substrate side toward the optical sheet side.

A planar illumination device according to an aspect of the disclosure can enhance the overall brightness uniformity at an emission surface.

### BRIEF DESCRIPTION OF DRAWINGS

FIG. 1 is a perspective view of a planar illumination device according to an embodiment as seen from the front side.

FIG. 2 is an exploded perspective view of the planar illumination device.

FIG. 3 is a cross-sectional view taken in the direction of arrows A-A in FIG. 1.

FIG. 4 is a cross-sectional view taken in the direction of arrows B-B in FIG. 1.

FIG. 5 is a cross-sectional view taken in the direction of arrows C-C in FIG. 1.

FIG. 6 is a plan view illustrating the distribution of brightness at an emission surface of a typical planar illumination device.

FIG. 7 is a cross-sectional view of a short side direction end part according to a comparative example similar to FIG. 3.

FIG. 8 is a cross-sectional view of a long side direction end part according to a comparative example similar to FIG. 4.

FIG. 9 is a cross-sectional view of a long side direction end part according to a comparative example similar to FIG. 5.

FIG. 10 is a cross-sectional view of a planar illumination device according to another embodiment similar to FIG. 3.

FIG. 11 is a cross-sectional view of a planar illumination device according to another embodiment similar to FIG. 4.

FIG. 12 is a cross-sectional view of a planar illumination device according to another embodiment similar to FIG. 5.

FIG. 13 is a cross-sectional view of a planar illumination device according to yet another embodiment similar to FIG. 5.

FIG. 14 is a plan view of a substrate and a reflector of a planar illumination device according to yet another embodiment.

FIG. 15 is a plan view of a substrate and a reflector of a planar illumination device according to yet another embodiment.

FIG. 16 is a plan view of a substrate and a reflector of a planar illumination device according to yet another embodiment.

FIG. 17 is a plan view of a substrate and a reflector of a planar illumination device according to yet another embodiment.

FIG. 18 is a cross-sectional view of a planar illumination device according to yet another embodiment similar to FIG. 3.

FIG. 19 is a cross-sectional view of a planar illumination device according to yet another embodiment similar to FIG. 4.

FIG. 20 is a perspective view illustrating a planar illumination device according to yet another embodiment.

### DESCRIPTION OF EMBODIMENTS

### First Embodiment

A planar illumination device 1 according to a first embodiment will be described below with reference to the drawings. Note that the disclosure is not limited by the following embodiment. Furthermore, the dimensional relationships between elements, proportions of the elements, and the like in the drawings may differ from reality. Among the drawings, parts having mutually different dimensional relationships and proportions may be included. Furthermore, the contents described in one embodiment are applied in principle to other embodiments.

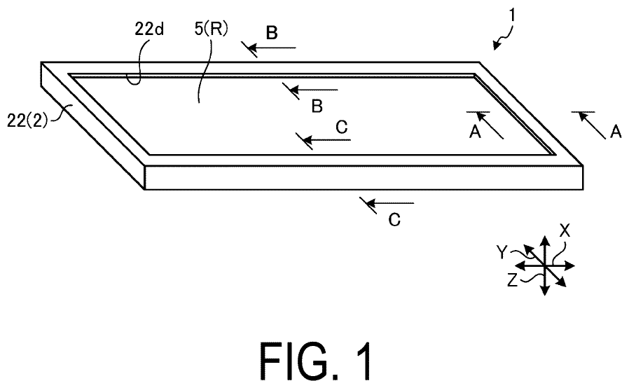

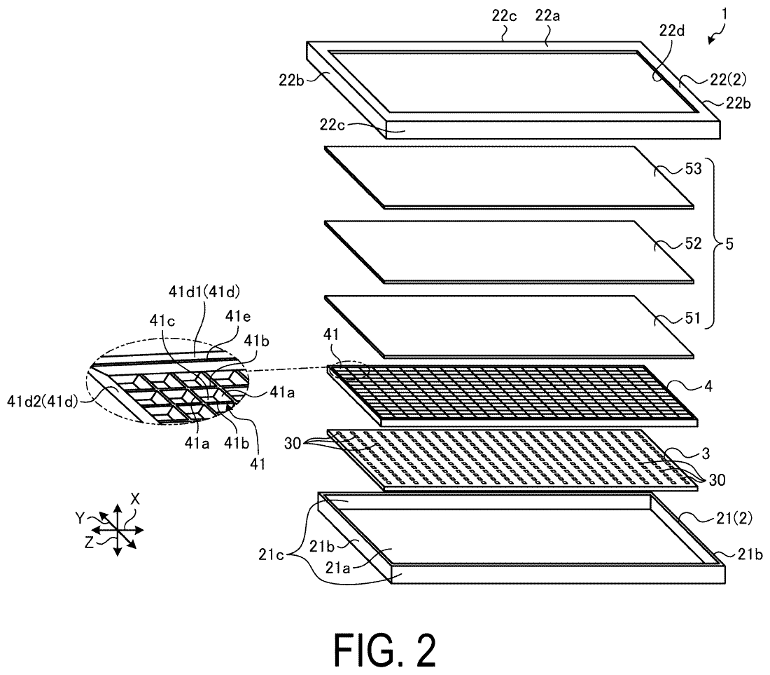

First, the overall configuration of the planar illumination device 1 according to the embodiment will be described using FIGS. 1 and 2. FIG. 1 is a perspective view of the planar illumination device 1 according to the first embodiment as seen from the front side. FIG. 2 is an exploded perspective view of the planar illumination device 1 according to the first embodiment. In FIGS. 1 and 2, for the sake of convenience, the long side direction, the short side direction, and the thickness direction of the planar illumination device 1 are referred to as the X-axis direction, the Y-axis direction, and the Z-axis direction, respectively. Furthermore, in the thickness direction, the side where an optical sheet 5 is disposed relative to a substrate 3 is referred to as an emission surface R side or as one surface side.

The planar illumination device 1 according to the embodiment is used as a backlight for various types of liquid crystal display devices and is a so-called direct-lit planar illumination device 1 including a plurality of light sources 30 described below and disposed directly under an emission surface R. The liquid crystal display device for the planar illumination device 1 is, for example, an electronic meter, an indicator, or a similar display installed in a vehicle.

As illustrated in FIG. 1, the planar illumination device 1 according to the embodiment includes the emission surface R defined by an opening 22d of a top frame 22 described below. The planar illumination device 1 functions as a backlight for the liquid crystal display device described above and emits light from the emission surface R.

As illustrated in FIG. 2, the planar illumination device 1 according to the embodiment includes a housing 2, the substrate 3, a reflector 4, and the optical sheet 5.

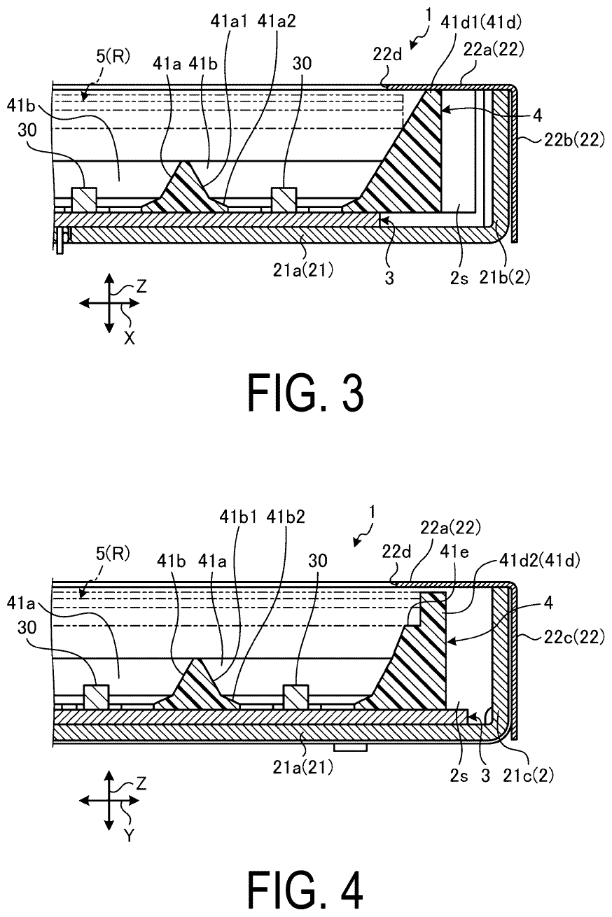

The housing 2 is a stainless steel frame having high rigidity, for example. Note that the housing 2 may be made of aluminum, magnesium, or the like. The housing 2 includes a bottom frame 21 and a top frame 22. The substrate 3, the reflector 4, and the optical sheet 5 are housed in an internal space 2s (see FIGS. 3, 4, and 5, for example) formed by the bottom frame 21 and the top frame 22. In other words, the substrate 3, the reflector 4, and the optical sheet 5 are housed in the housing 2.

The bottom frame 21 is formed in a box-like shape with a closed bottom and functions as the base of the housing 2. Also, the bottom frame 21 is formed of a bottom part 21a, a pair of first side walls 21b, and a pair of second side walls 21c. The bottom part 21a has a rectangular shape as seen from the front side and defines the shape of the planar illumination device 1 as seen from the front side. The pair of first side walls 21b face each other in the long side direction and are continuous in the short side direction. The pair of second side walls 21c face each other in the short side direction and are continuous in the long side direction.

The top frame 22 is disposed at the side in the direction of light emission, the side being one surface side of the bottom frame 21 in the thickness direction, and functions as the lid of the housing 2. Also, the top frame 22 is formed of a top plate 22a, a pair of first side walls 22b, and a pair of second side walls 22c. The opening 22d is formed in a center part of the top plate 22a, and the emission surface R described above is defined by the opening 22d. The pair of first side walls 22b face each other in the long side direction and are continuous in the short side direction. The pair of second side walls 22c face each other in the short side direction and are continuous in the long side direction.

As illustrated in FIGS. 3, 4, and 5, regarding the housing 2, by inserting the pair of first side walls 21b and the pair of second side walls 21c of the bottom frame 21 at the inner side of the pair of first side walls 22b and the pair of second side walls 22c of the top frame 22, the top frame 22 and the bottom frame 21 are assembled together, and the internal space 2s is formed (see FIGS. 3, 4, and 5). In other words, in the planar illumination device 1 according to the present embodiment, the pair of first side walls 21b and the pair of second side walls 21c of the bottom frame 21 form the inner wall of the housing 2, and the pair of first side walls 22b and the pair of second side walls 22c of the top frame 22 form the outer wall of the housing 2.

The substrate 3 is a circuit board formed of an epoxy resin or polyimide (PI), for example, and a flexible printed circuit (FPC) can be used, for example. The substrate 3 is provided at the one surface of the bottom frame 21 in the thickness direction. At the emission surface R side of the substrate 3, for example, a white resist layer is formed. The resist layer reflects light from the light sources 30 to the emission surface R side. Also, the plurality of light sources 30 are provided at the one surface side of the substrate 3 (see FIG. 4). In other words, the planar illumination device 1 includes the substrate 3, with the plurality of light sources 30 provided at the substrate 3 at the one surface side.

The light sources 30 are point light sources 30, for example, and light emitting diodes (LEDs) can be used. Package-type LEDs or chip-type LEDs can be used for the light sources 30, for example, but no such limitation is intended. Note that the light sources 30 are not limited to being LEDs, and a discretionary light-emitting member can be used. Each one of the plurality of light sources 30 according to the present embodiment emits the same amount of light.

Also, the plurality of light sources 30 are arranged in a rectangular pattern in the long side direction and the short side direction. More specifically, for example, the plurality of light sources 30 are arranged at predetermined intervals in the long side direction and at predetermined intervals in the short side direction, forming a grid-like pattern with rows and columns of even intervals.

The reflector 4 is made of synthetic resin, for example, and has a function of reflecting light emitted from the light source 30 to the emission surface R side to enhance the brightness at the emission surface R side. This allows the emission efficiency of the planar illumination device 1 to be enhanced. The reflector 4 is provided at the one surface side of the substrate 3 in the thickness direction. In other words, the planar illumination device 1 includes the reflector 4 provided at the one surface side of the substrate 3. The reflector 4 according to the present embodiment is integrally formed, for example, by injection molding of a synthetic resin, for example, a white polycarbonate or the like. In other words, the planar illumination device 1 of the present embodiment includes a solitary reflector 4.

Also, the reflector 4 includes reflecting parts 41 in a grid-like pattern corresponding to the light sources 30 mounted at the substrate 3. Each reflecting part 41 includes a pair of first reflecting parts 41a facing each other in the long side direction, a pair of second reflecting parts 41b facing each other in the short side direction, and a space part 41c formed by the pair of first reflecting parts 41a and the pair of second reflecting parts 41b. The first reflecting part 41a illustrated in FIG. 3 includes an emission surface side reflective surface 41a1 and a substrate side reflective surface 41a2 having different angles with respect to the plane including the long side direction and the short side direction. Also, the intersection angle between the substrate side reflective surface 41a2 and the plane including the long side direction and the short side direction is smaller than the intersection angle between the emission surface side reflective surface 41a1 and the plane including the long side direction and the short side direction. The second reflecting part 41b illustrated in FIG. 4 includes an emission surface side reflective surface 41b1 and a substrate side reflective surface 41b2 having different angles with respect to the plane including the long side direction and the short side direction. Also, the intersection angle between the substrate side reflective surface 41b2 and the plane including the long side direction and the short side direction is smaller than the intersection angle between the emission surface side reflective surface 41b1 and the plane including the long side direction and the short side direction.

The optical sheet 5 is disposed at the emission surface R side of the reflector 4 in the thickness direction. The planar illumination device 1 of the present embodiment includes three optical sheets 51, 52, and 53, for example. The optical sheet 5 adjusts the light distribution and brightness of light passing from the other surface side to the one surface side in the thickness direction and homogenizes the light emitted from the emission surface R, for example.

The optical sheet 51 is formed of plate-like polycarbonate or plate-like polycarbonate and a diffusion sheet. The thickness of plate-like polycarbonate ranges from 1 mm to 1.5 mm, for example. The optical sheet 52 is a prism sheet, a brightness enhancement film (BEF), or the like, for example. The optical sheet 53 is a reflective polarizer film, a dual brightness enhancement film (DBEF), or the like, for example.

The planar illumination device 1 according to the present embodiment has the following configuration in order to enhance the overall brightness uniformity at the emission surface R.

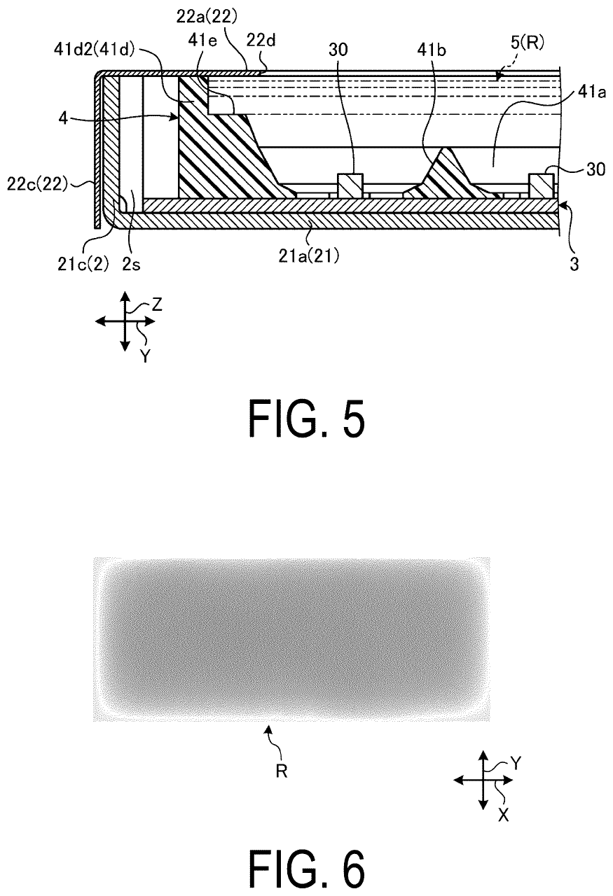

As illustrated in FIGS. 2, 3, 4, and 5, the reflector 4 includes an inclined side wall 41d around the periphery of the reflector 4. The inclined side wall 41d decreases in width from the substrate 3 side toward the optical sheet 5 side. Also, the periphery of the optical sheet 5 is covered by the inclined side wall 41d. In other words, the periphery of the optical sheet 5 is covered by the reflector 4. The inclined side wall 41d includes first inclined side walls 41d1 (see FIG. 3) located at short side direction end parts and second inclined side walls 41d2 (see FIGS. 4 and 5) located at long side direction end parts. The short side direction end parts extend in the short side direction, and the long side direction end parts extend in the long side direction. As illustrated in FIGS. 4 and 5, the second inclined side wall 41d2 includes a step part 41e partway along the thickness direction. The long side direction end part of the optical sheet 5 is supported by the step part 41e. In other words, the long side direction end parts of the optical sheet 5 are supported by the step parts 41e provided at the emission surface R side of the second inclined side walls 41d2. The step part 41e, for example, forms a horizontal surface orthogonal to the thickness direction and is formed continuously in the long side direction from one end part to the other end part. The second inclined side walls 41d2 (inclined side wall 41d) are located adjacent to the long side direction end parts of the optical sheet 5. Also, as illustrated in FIG. 3, the first inclined side walls 41d1 (inclined side wall 41d) are located adjacent to the short side direction end parts of the optical sheet 5. A step part is not provided in the first inclined side walls 41d1.

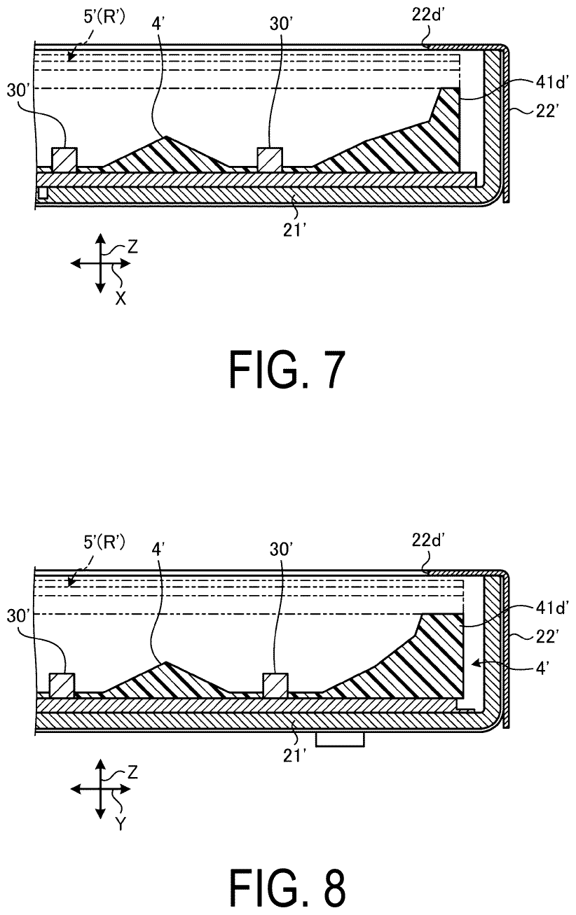

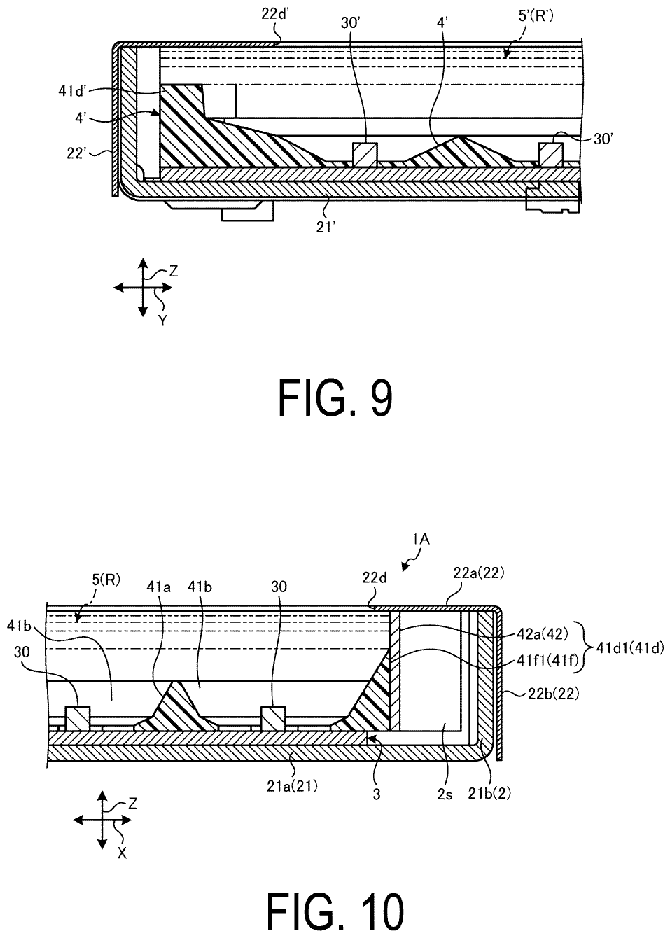

FIG. 7 is a cross-sectional view of a short side direction end part according to a comparative example similar to FIG. 3. FIG. 8 is a cross-sectional view of a long side direction end part according to a comparative example similar to FIG. 4. FIG. 9 is a cross-sectional view of a long side direction end part according to a comparative example similar to FIG. 5.

A planar illumination device 1′ illustrated in the comparative example is a direct-lit type. The planar illumination device 1′ includes a housing 2′ formed of a bottom frame 21′ and a top frame 22′. The top frame 22′ includes an opening 22d′, and an emission surface R′ is defined by the opening. A reflector 4′ in the planar illumination device 1′ includes an inclined side wall 41d′. The inclined side wall 41d′ decreases in width from a substrate 3′ side toward an optical sheet 5′ side. In the reflector 4′, a tip part of the inclined side wall 41d′ in the thickness direction is in contact with the optical sheet 5′, and the inclined side wall 41d′ supports the optical sheet 5′. Thus, in the planar illumination device 1′, the periphery of the optical sheet 5′ is not covered by the reflector 4′. Accordingly, light leaking out from the periphery of the optical sheet 5′ is not emitted from the opening 22d′ of the top frame 22′, causing a loss inside the frame. As a result, as illustrated in FIG. 6, in the planar illumination device 1′, the brightness at a center part of the emission surface R in the long side direction and the short side direction is high, and the brightness at the outer peripheral part (particularly, the four corners) is low. In other words, the overall brightness uniformity of the emission surface R′ of the planar illumination device 1′ is low.

In contrast, the periphery of the optical sheet 5 of the planar illumination device 1 according to the embodiment is covered by the reflector 4. Thus, the light emitted from the light sources 30, including the light leaking out from the periphery of the optical sheet 5, is reflected to the emission surface R side by the inclined side wall 41d of the reflector 4 located at the periphery of the optical sheet 5. Thus, the planar illumination device 1 according to the present embodiment can enhance the brightness at the outer peripheral part of the emission surface R, allowing the overall brightness uniformity of the emission surface R to be enhanced.

Also, at least a part of the long side direction end parts of the optical sheet 5 of the planar illumination device 1 according to the present embodiment is supported by the step part 41e provided at the emission surface side of the inclined side wall 41d2. Thus, in the planar illumination device 1, even when the length of the optical sheet 5 in the long side direction is increased, since the optical sheet 5 is supported by the step part 41e, the emission surface R can be formed flat. In addition, the inclined side walls are located adjacent to the short side direction end parts of the optical sheet. Thus, the planar illumination device 1 can have a narrower frame in the short side direction.

The embodiment of the disclosure has been described above, but the disclosure is not limited to the embodiment described above, and various modifications are possible without departing from the spirit of the disclosure.

### Second Embodiment

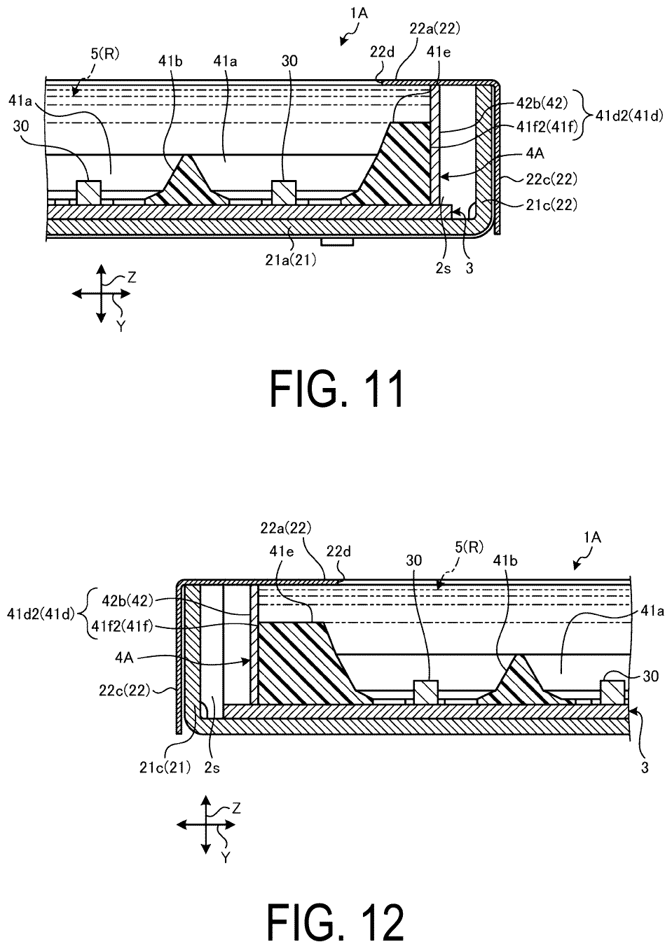

FIG. 10 is a cross-sectional view of a planar illumination device 1A similar to FIG. 3. FIG. 11 is a cross-sectional view of the planar illumination device 1A similar to FIG. 4. FIG. 12 is a cross-sectional view of the planar illumination device 1A similar to FIG. 5. In the planar illumination device 1 according to the first embodiment described above, the inclined side wall 41d is integrally formed. The planar illumination device 1A according to the second embodiment is different from the planar illumination device 1 according to the first embodiment in that, as described below, in a reflector 4A, the inclined side wall 41d includes an opposing surface 41f facing the inner wall of the housing 2 and an opposing surface reflective sheet 42 formed separate to the opposing surface 41f.

The inclined side wall 41d includes the first inclined side wall 41d1 facing the first side wall 21b included in the inner wall of the housing 2 as illustrated in FIG. 10 and the second inclined side wall 41d2 facing the second side wall 21c included in the inner wall of the housing 2 as illustrated in FIGS. 11 and 12.

The opposing surface 41f includes a first opposing surface 41f1 facing the first side wall 21b included in the inner wall of the housing 2 as illustrated in FIG. 10 and a second opposing surface 41f2 facing the second side wall 21c included in the inner wall of the housing 2 as illustrated in FIGS. 11 and 12.

Each opposing surface reflective sheet 42 reflects light emitted from the light sources 30. For the opposing surface reflective sheet 42, for example, a multilayer film sheet, a foam white reflector, a white polyethylene terephthalate film, a silver reflective sheet, or the like can be used. The opposing surface reflective sheet 42 with such a configuration is provided continuously at the periphery of the opposing surface 41f, for example. The opposing surface reflective sheet 42 includes a first opposing surface reflective sheet 42a located at the first opposing surface 41f1 as illustrated in FIG. 10 and a second opposing surface reflective sheet 42b located at the second opposing surface 41f2 as illustrated in FIGS. 11 and 12. Also, the step part 41e of the planar illumination device 1A according to the present embodiment is formed of the second opposing surface reflective sheet 42b and the tip part of the inclined side wall 41d facing the second side wall 21c.

The inclined side wall 41d of the planar illumination device 1A according to the present embodiment includes the opposing surfaces 41f1 and 41f2 facing the first side walls 21b and the second side walls 21c forming the inner wall of the housing 2 and the opposing surface reflective sheet 42 for reflecting the light emitted from the light sources 30, the opposing surface reflective sheet 42 being located at each of the opposing surfaces 41f1 and 41f2. Accordingly, in the planar illumination device 1A according to the present embodiment, the opposing surface reflective sheet 42 located at each of the opposing surfaces 41f1 and 41f2 reflects the light emitted from the light sources 30, including the light leaking out from the periphery of the optical sheet 5. Thus, the planar illumination device 1A according to the present embodiment can enhance the brightness at the outer peripheral part of the emission surface R, allowing the overall brightness uniformity of the emission surface R to be further enhanced.

### Third Embodiment

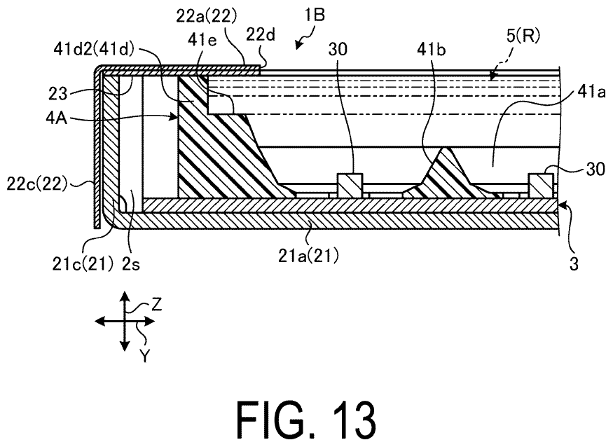

FIG. 13 is a cross-sectional view of a planar illumination device 1B similar to FIG. 5. In the planar illumination device 1 according to the first embodiment described above, the inner surface of the top plate 22a of the top frame 22 is exposed to the internal space 2s. The planar illumination device 1B according to the third embodiment is different from the planar illumination device 1 according to the first embodiment in that a top frame reflective sheet 23 is provided at the inner surface of the top frame 22, with the top frame reflective sheet 23 covering the inner surface of the top plate 22a.

The inner surface of the top frame 22 of the planar illumination device 1B according to the present embodiment is provided with the top frame reflective sheet 23 for reflecting the light emitted from the light sources 30. The top frame reflective sheet 23 is provided continuously along the edge of the opening 22d at the periphery of the opening 22d, for example. For the top frame reflective sheet 23, for example, a multilayer film sheet, a foam white reflector, a white polyethylene terephthalate film, a silver reflective sheet, or the like can be used.

The inner surface of the top frame 22 of the planar illumination device 1B according to the present embodiment is provided with the top frame reflective sheet 23 for reflecting the light emitted from the light sources 30. Thus, in the planar illumination device 1B according to the present embodiment, the reflector 4 can reflect light inside the frame to the emission surface R side after the top frame reflective sheet 23 reflects the light. Thus, the planar illumination device 1B according to the present embodiment can enhance the brightness at the outer peripheral part of the emission surface R, allowing the overall brightness uniformity of the emission surface R to be further enhanced.

Note that in the planar illumination device 1B of the embodiment described above, the inner wall of the housing 2 is formed of the pair of first side walls 21b and the pair of second side walls 21c of the bottom frame 21. However, in the planar illumination device 1B of the present embodiment, the inner wall of the housing 2 may be formed of the pair of first side walls 22b and the pair of second side walls 22c of the top frame 22.

### Fourth Embodiment

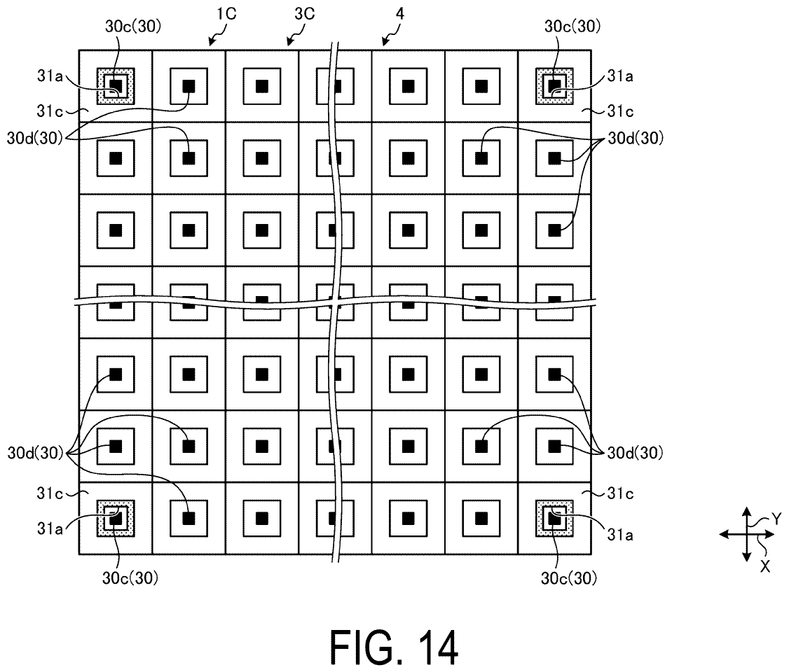

FIG. 14 is a plan view illustrating a substrate 3C and the reflector 4 of a planar illumination device 1C. In the planar illumination device 1 according to the first embodiment described above, the white resist layer is provided at the emission surface R side of the substrate 3. The planar illumination device 1C according to the fourth embodiment is different from the planar illumination device 1 according to the first embodiment in that, instead of the resist layer, a light source reflective sheet 31C is provided at a part of the substrate 3C at the emission surface R side.

The substrate 3C of the planar illumination device 1C according to the present embodiment includes the plurality of light sources 30. In the planar illumination device 1C according to the present embodiment, the light source reflective sheet 31C is provided at a part of the substrate 3C. The light source reflective sheet 31C has a function of re-reflecting, of the light emitted from the light sources 30, the light reflected at the optical sheet 5 to the emission surface R side. For the light source reflective sheet 31C, for example, a multilayer film sheet, a foam white reflector, a white polyethylene terephthalate film, a silver reflective sheet, or the like can be used. The light reflectivity of the light source reflective sheet 31C ranges from 80% to 98%, for example. The light source reflective sheet 31C includes a sheet opening 31a exposing the head part of the light source 30 at the one surface side. The sheet opening 31a is formed in a square shape, for example.

In FIG. 14, the light source reflective sheets 31C are provided in the dotted parts, and the light source reflective sheets 31C are not provided in the undotted parts. In other words, in the planar illumination device 1C, the light source reflective sheets 31C for reflecting light to the emission surface R side are provided at the periphery of four corner light sources 30c, from among the plurality of light sources 30, located at the long side direction end parts and at the short side direction end parts. The light source reflective sheets 31C are not provided at the periphery of non-corner light sources 30d, from among the plurality of light sources 30.

In the planar illumination device 1C according to the present embodiment, the light source reflective sheets 31C for reflecting light to the emission surface R side are provided at the periphery of four corner light sources 30c, from among the plurality of light sources 30, located at the long side direction end parts and at the short side direction end parts. As a result, the planar illumination device 1C according to the present embodiment can enhance the brightness at the four corners at the emission surface R, allowing the overall brightness uniformity of the emission surface R to be even further enhanced. In particular, the planar illumination device 1C according to the present embodiment can achieve the advantages and effects described above with a simple configuration by simply providing the light source reflective sheets 31C at the periphery of the four corner light sources 30c.

### Fifth Embodiment

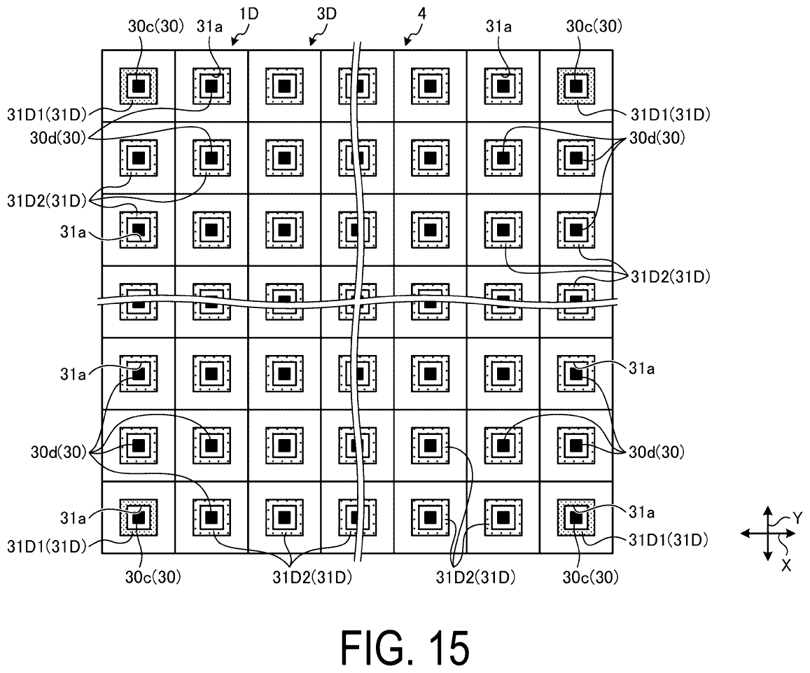

FIG. 15 is a plan view illustrating a substrate 3D and the reflector 4 of a planar illumination device 1D. In the planar illumination device 1C according to the fourth embodiment described above, the light source reflective sheet 31C is provided at a part of the substrate 3C at the emission surface R side. The planar illumination device 1D according to the fifth embodiment is different from the planar illumination device 1C according to the fourth embodiment in that a light source reflective sheet 31D is provided across the entire surface of the substrate 3D at the emission surface R side.

Of the light source reflective sheets 31D, as illustrated in FIG. 15, first light source reflective sheets 31D1 are provided in the well-dotted parts and second light source reflective sheets 31D2 are provided in the sparsely-dotted parts. In other words, the light source reflective sheets 31D of the planar illumination device 1D according to the present embodiment include the first light source reflective sheets 31D1 disposed at the periphery of the four corner light sources 30c located at the long side direction end parts and at the short side direction end parts and the second light source reflective sheets 31D2 disposed at the periphery of the non-corner light sources 30d. The light reflectivity of the first light source reflective sheet 31D1 is higher than the light reflectivity of the second light source reflective sheet 31D2. For example, the light reflectivity of the first light source reflective sheet 31D1 ranges from 90% to 98%, and the light reflectivity of the second light source reflective sheet 31D2 ranges from 80% to 89%. Also, the sheet openings 31a of the same size are formed in the light source reflective sheet 31D, corresponding to the light sources 30.

In the light source reflective sheet 31D of the planar illumination device 1D according to the present embodiment, the light emitted from the non-corner light sources 30d is reflected by the second light source reflective sheets 31D2, and the light emitted from the four corner light sources 30c is reflected by the first light source reflective sheets 31D1 having a higher light reflectivity than the second light source reflective sheets 31D2. As a result, the planar illumination device 1D according to the present embodiment can enhance the brightness at the four corners at the emission surface R with respect to the brightness at the parts other than the four corners, allowing the overall brightness uniformity of the emission surface R to be even further enhanced. In particular, since the second light source reflective sheets 31D2 are provided at the periphery of the non-corner light sources 30d, the planar illumination device 1D according to the present embodiment can enhance the brightness even at the parts other than the four corners.

### Sixth Embodiment

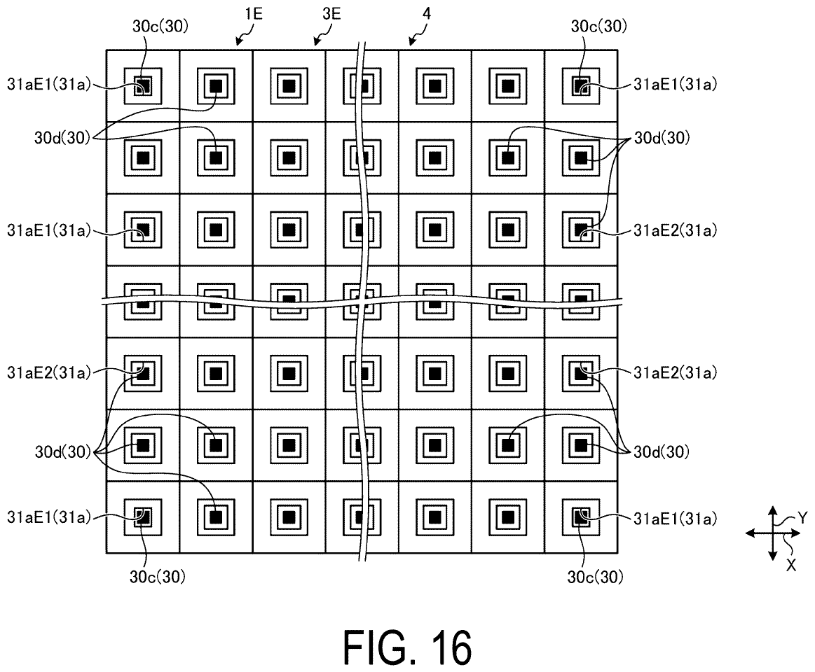

FIG. 16 is a plan view illustrating a substrate 3E and the reflector 4 of a planar illumination device 1E. In the planar illumination device 1D according to the fifth embodiment described above, the light source reflective sheet 31D includes the sheet openings 31a of the same size. The planar illumination device 1E according to the sixth embodiment is different from the planar illumination device 1D according to the fifth embodiment in that, as described below, the sizes of the sheet openings 31a formed at the light source reflective sheets 31E, corresponding to the positions of the light sources 30, are different.

Of the sheet openings 31a of light source reflective sheets 31E of the planar illumination device 1E according to the present embodiment, first sheet openings (sheet openings) 31aE1 disposed at the periphery of the four corner light sources 30c located at the long side direction end parts and at the short side direction end parts are smaller in size than second sheet openings (sheet openings) 31aE2 disposed at the periphery of the non-corner light sources 30d. For example, for the first sheet opening 31aE1, the gap between the edge of the light source 30c and the edge of the light source reflective sheet 31E is 1 mm, and for the second sheet opening 31aE2, the gap between the edge of the light source 30d and the edge of the light source reflective sheet 31E is 2 mm.

In the light source reflective sheets 31E of the planar illumination device 1E according to the present embodiment, the light emitted from the non-corner light sources 30d is reflected by the light source reflective sheets 31E including the second sheet openings 31aE2, and the light emitted from the four corner light sources 30c is reflected by the light source reflective sheets 31E including the first sheet openings 31aE1 smaller than the second sheet openings 31aE2. As a result, the planar illumination device 1E according to the present embodiment can enhance the brightness at the four corners at the emission surface R with respect to the brightness at the parts other than the four corners, allowing the overall brightness uniformity of the emission surface R to be even further enhanced. In particular, the planar illumination device 1E according to the present embodiment can achieve the advantages and effects described above with a simple configuration by simply changing the sizes of the sheet openings 31a formed in the light source reflective sheets 31E, depending on position.

### Seventh Embodiment

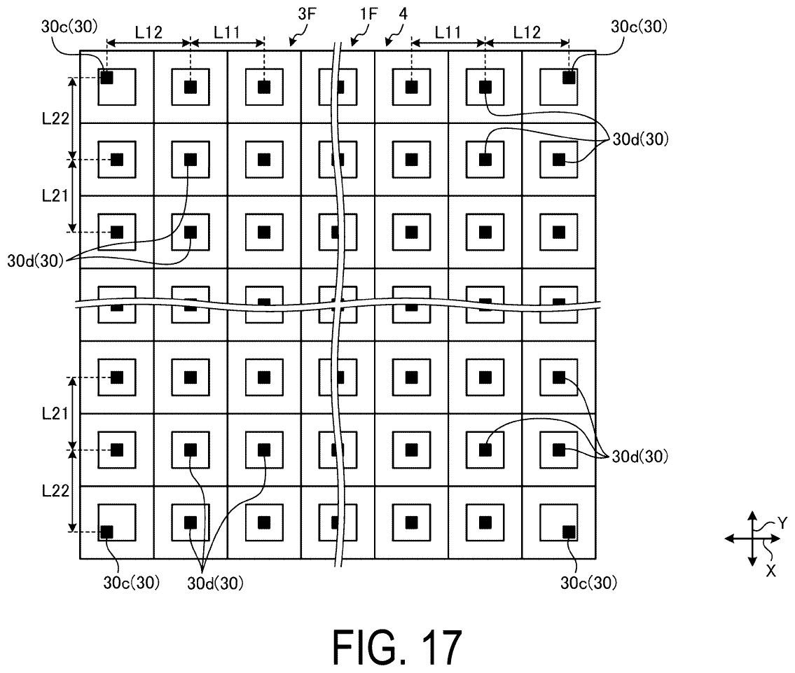

FIG. 17 is a plan view illustrating a substrate 3F and the reflector 4 of a planar illumination device 1F. In the planar illumination device 1 according to the first embodiment described above, the plurality of light sources 30 are disposed in a grid-like pattern with rows and columns of even intervals. The planar illumination device 1F according to the seventh embodiment is different from the planar illumination device 1 according to the first embodiment in that the arrangement of the light sources 30 is changed as described below depending on the position of the light sources 30.

In the planar illumination device 1F according to the present embodiment, from among the plurality of light sources 30, the light sources 30d other than the four corner light sources 30c located at the long side direction end parts and at the short side direction end parts are arranged at predetermined intervals. More specifically, the light sources 30d other than the four corner light sources 30c are arranged at a predetermined interval L11 in the long side direction and at a predetermined interval L21 in the short side direction. From among a plurality of light sources 30, each of the four corner light sources 30c has an interval L12 with the light source 30d adjacent in the long side direction, the interval L12 being larger than the predetermined interval L11, and an interval L22 with the light source 30d adjacent in the short side direction, the interval L22 being larger than the predetermined interval L21.

In the planar illumination device 1F according to the present embodiment, the light sources 30d other than the four corner light sources 30c are arranged at the predetermined intervals, and each of the four corner light sources 30c and the adjacent light source are arranged at an interval larger than the predetermined interval. As a result, the planar illumination device 1F according to the present embodiment can enhance the brightness at the four corners at the emission surface R with respect to the brightness of the parts other than the four corners due to the four corner light sources 30c being disposed at the corners of the rectangular emission surface R, allowing the overall brightness uniformity of the emission surface R to be even further enhanced. In particular, the planar illumination device 1F according to the present embodiment can achieve the advantages and effects described above with a simple configuration by simply changing the arrangement of the four corner light sources 30c with respect to the arrangement of the light sources 30d other than the four corner light sources 30c.

### Eighth Embodiment

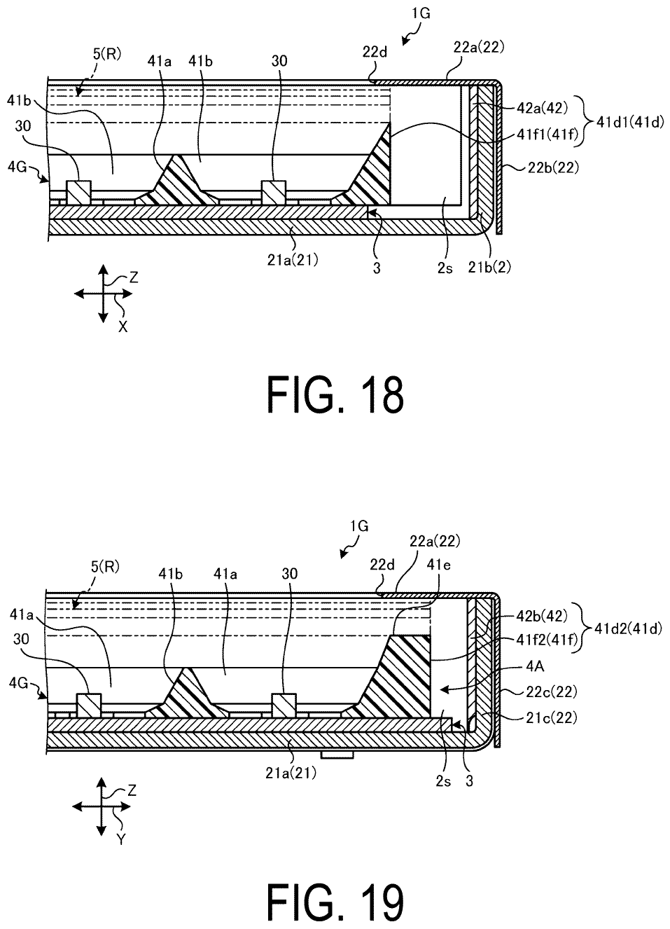

FIG. 18 is a cross-sectional view of a planar illumination device 1G similar to FIG. 3. FIG. 19 is a cross-sectional view of the planar illumination device 1G similar to FIG. 4. In the planar illumination device 1 according to the first embodiment described above, the inclined side wall 41d is integrally formed. The planar illumination device 1G according to the eighth embodiment is different from the planar illumination device 1 according to the first embodiment in that, as described below, in a reflector 4G, the inclined side wall 41d includes the opposing surface 41f facing the inner wall of the housing 2 and the opposing surface reflective sheet 42 provided at the inner wall of the housing 2.

The inclined side wall 41d includes the first inclined side wall 41d1 facing the first side wall 21b included in the inner wall of the housing 2 as illustrated in FIG. 18 and the second inclined side wall 41d2 facing the second side wall 21c included in the inner wall of the housing 2 as illustrated in FIG. 19.

The opposing surface 41f includes the first opposing surface 41f1 facing the first side wall 21b included in the inner wall of the housing 2 as illustrated in FIG. 18 and the second opposing surface 41f2 facing the second side wall 21c included in the inner wall of the housing 2 as illustrated in FIG. 19.

Each opposing surface reflective sheet 42 reflects light emitted from the light sources 30. For the opposing surface reflective sheet 42, for example, a multilayer film sheet, a foam white reflector, a white polyethylene terephthalate film, a silver reflective sheet, or the like can be used. The opposing surface reflective sheet 42 with such a configuration is provided continuously at the periphery of the inner wall, for example. The opposing surface reflective sheet 42 includes the first opposing surface reflective sheet 42a located at the first side wall 21b included in the inner wall of the housing 2 as illustrated in FIG. 18 and the second opposing surface reflective sheet 42b located at the second side wall 21c included in the inner wall of the housing 2 as illustrated in FIG. 19. Also, the step part 41e of the planar illumination device 1G according to the present embodiment is formed of the second opposing surface reflective sheet 42b and the tip part of the inclined side wall 41d facing the second side wall 21c.

The inclined side wall 41d of the planar illumination device 1G according to the present embodiment includes the opposing surfaces 41f1 and 41f2 facing the first side wall 21b and the second side wall 21c forming the inner wall of the housing 2 and the opposing surface reflective sheet 42 for reflecting the light emitted from the light sources 30, the opposing surface reflective sheet 42 being located at the inner wall of the housing 2. Accordingly, in the planar illumination device 1G according to the present embodiment, the opposing surface reflective sheet 42 located at each of the opposing surfaces 41f1 and 41f2 reflects the light emitted from the light sources 30, including the light leaking out from the periphery of the optical sheet 5. Thus, the planar illumination device 1G according to the present embodiment can enhance the brightness at the outer peripheral part of the emission surface R, allowing the overall brightness uniformity of the emission surface R to be further enhanced.

### Other Embodiments

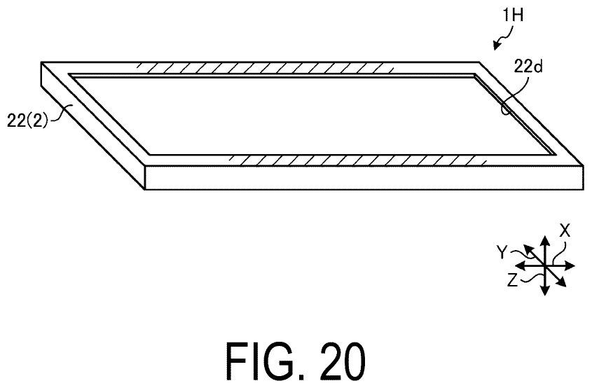

Note that the step part 41e included in the second inclined side wall 41d2 in the embodiment described above is formed continuously from one end part to the other end part in the long side direction. However, the step part 41e included in the second inclined side wall 41d2 in a planar illumination device 1H of the present embodiment may be formed only in a center part in the long side direction, as illustrated via hatching in FIG. 20, and need not be formed in the long side direction end parts. In other words, in the planar illumination device 1H of the present embodiment, at least a part of the long side direction end parts of the optical sheet 5 is supported by the step part 41e provided at the emission surface R side of the inclined side wall 41d.

Also, in the planar illumination device 1 according to the embodiment described above, a white resist layer is provided at the emission surface R side of the substrate 3. In the planar illumination devices 1C, 1D, and 1E, the light source reflective sheets 31C, 31D, and 31E are provided at the emission surface R side of the substrate 3. In the planar illumination devices 1C, 1D, and 1E, a white resist layer may be formed at the emission surface R of the substrate 3 exposed through the sheet openings 31a of the light source reflective sheets 31C, 31D, and 31E.

Furthermore, in the planar illumination devices 1, 1A, 1B, 1C, 1D, 1E, 1F, 1G, and 1H of the embodiments described above, the sheet openings 31a of the light source reflective sheets 31C, 31D, and 31E are formed in a rectangular shape. However, the shape of the sheet openings 31a of the light source reflective sheets 31C, 31D, and 31E of the planar illumination device 1 of the present embodiment are not limited to this shape and can be changed to an appropriate shape, such as a circle, an ellipse, a polygon, and the like, depending on the shape of the light sources 30.

Also, for the plurality of light sources 30 in the planar illumination devices 1, 1A, 1B, 1C, 1D, 1E, 1F, 1G, and 1H of the embodiments described above, the amount of light emitted from each light source 30 is the same. However, for the plurality of light sources 30 in the planar illumination devices 1, 1A, 1B, 1C, 1D, 1E, 1F, 1G, and 1H according to the present embodiment, the amount of light may be changed depending on the position in the long side direction and the short side direction. For example, the amount of light of the four corner light sources 30c located at long side direction end parts and short side direction end parts may be large, and the amount of light of the non-corner light sources 30d may be small compared with the light sources 30c.

Moreover, the disclosure is not limited to the embodiments described above. A configuration obtained by appropriately combining the above-mentioned constituent elements is also included in the disclosure. Further effects and modification examples can be easily derived by a person skilled in the art. Thus, a wide range of aspects of the disclosure is not limited to the embodiments described above and may be modified variously.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A planar illumination device comprising:
a substrate provided with a plurality of light sources at one surface side;
a reflector provided at the one surface side of the substrate; and
an optical sheet provided at an emission surface side of the reflector, wherein
the reflector covers a periphery of the optical sheet, and
the reflector includes an inclined side wall at a periphery, the inclined side wall decreasing in width from the substrate side toward the optical sheet side.

2. The planar illumination device according to claim 1, wherein
at least a part of a long side direction end part of the optical sheet is supported by a step part provided at the emission surface side of the inclined side wall, and
the inclined side wall is located adjacent to a short side direction end part of the optical sheet.

3. The planar illumination device according to claim 1, wherein
the substrate, the reflector, and the optical sheet are housed in a housing, and
the inclined side wall includes an opposing surface facing an inner wall of the housing and an opposing surface reflective sheet configured to reflect light emitted from the light sources, the opposing surface reflective sheet being located at the opposing surface.

4. The planar illumination device according to claim 1, wherein
the substrate, the reflector, and the optical sheet are housed in a housing, and
the inclined side wall includes an opposing surface facing an inner wall of the housing and an opposing surface reflective sheet configured to reflect light emitted from the light sources, the opposing surface reflective sheet being located at the inner wall.

5. The planar illumination device according to claim 1, wherein
the plurality of light sources are disposed in a rectangular pattern in a long side direction and a short side direction, and
a light source reflective sheet configured to reflect light to the emission surface side is provided at a periphery of the light sources at four corners located at the long side direction end parts and the short side direction end parts, from among the plurality of light sources.

6. The planar illumination device according to claim 1, wherein
the plurality of light sources are disposed in a rectangular pattern in a long side direction and a short side direction,
the substrate is provided with a light source reflective sheet configured to reflect light to the emission surface side,
the light source reflective sheet includes a first light source reflective sheet disposed at the periphery of the light sources at four corners located at the long side direction end parts and the short side direction end parts and a second light source reflective sheet disposed at a periphery of the light sources not at the four corners, and
the first light source reflective sheet has a higher light reflectivity than the second light source reflective sheet.

7. The planar illumination device according to claim 1, wherein
the plurality of light sources are disposed in a rectangular pattern in a long side direction and a short side direction,
the substrate is provided with a light source reflective sheet configured to reflect light to the emission surface side,
the light source reflective sheet includes a sheet opening exposing a head part of each of the light sources, and
from among the sheet openings, the sheet opening disposed at the periphery of the light sources at four corners located at the long side direction end parts and the short side direction end parts is smaller in size than the sheet opening disposed at the periphery of the light sources not at the four corners.

8. The planar illumination device according to claim 1, wherein
the plurality of light sources are disposed in a rectangular pattern in a long side direction and a short side direction,
from among the plurality of light sources, light sources other than the light sources disposed at four corners located at the long side direction end parts and the short side direction end parts are disposed at a predetermined interval, and
from among the plurality of light sources, the light sources disposed at the four corners have an interval with the light source adjacent in the long side direction, the interval being larger than the predetermined interval and have an interval with the light source adjacent in the short side direction, the interval being larger than the predetermined interval.

9. The planar illumination device according to claim 1, wherein
the substrate, the reflector, and the optical sheet are housed in a housing,
the housing includes a top frame including an opening forming the emission surface, and
a top frame reflective sheet configured to reflect light emitted from the light sources is provided at an inner surface of the top frame.
